(19) United States
(12) Patent Application Publication
(10) Pub. No.: US 2004/0080197 A1
(43) Pub. Date: Apr. 29, 2004

(54) Transmission amplifier for bowden cables and method of using the same

(76) Inventor: Robert Kopetzky, Lauf (DE)

Correspondence Address: HUSCH & EPPENBERGER, LLC, 190 CARONDELET PLAZA, SUITE 600, ST. LOUIS, MO, 63105-3441, US

(21) Appl. No.: 10/280,921

(22) Filed: Oct. 25, 2002

(51) Int. Cl. B60N 2/66

(52) U.S. Cl. 297/284.4

(57) ABSTRACT

A bowden cable transmission is provided between the actuator and the lumbar support member of an adjustable lumbar support assembly. The bowden cable transmission converts movement of a first wire of a first bowden cable attached to the actuator into movement of a second wire of a second bowden cable attached to the lumbar support member. The bowden cable transmission converts the motions in a non-proportional manner such that the movement of the second wire in response to the movement of the first wire changes as the movement of the first wire is altered.

### STATEMENT REGARDING RELATED APPLICATIONS

None.

### STATEMENT REGARDING FEDERALLY SPONSORED FUNDING

None.

### BACKGROUND OF THE INVENTION

(1) Field of the Invention

This invention pertains to the field of bowden cable actuator assemblies. More particularly, the invention pertains to a transmission device for and method of converting motion of the wire of a first bowden cable into motion of the wire of a second bowden cable at a non-proportional rate. The non-proportional conversion of movement between the two bowden cables allows a constant rate of motion of the wire within the first bowden cable to result in a non-constant rate of motion of the wire within the second bowden cable. The preferred embodiments of the invention are specifically developed for use in adjustable lumbar support assemblies of automobile seats.

(2) Description of the Related Art

Adjustable lumbar support assemblies are widely used in automobile seats. Many adjustable lumbar support connected to an actuator via a bowden cable. The bowden cable of such assemblies transmits motion and power from the actuator to the lumbar support member to allow adjustment of the contour of the lumbar support member. Bowden cables are flexible conduits or sleeves containing wires that slide axially through the conduit.

The adjustable lumbar support member of an assembly is typically a thin panel flexible member that is positioned in the seat where it will support the lumbar region of a person's back when the person is seated therein. Typically, the lumbar support member is made adjustable by changing its curvature in a manner such that it extends more or less toward the person's back. Several different methods are commonly used to change the curvature of the lumbar support member. One method is to apply a bending moment to either the top or bottom end margin of the support member in a manner such that the support portion's curvature increases or decreases. Another common method is to force the top and bottom end margins of the support member toward each other such that the support member bows outward.

One end of a bowden cable is typically attached to the support member to either supply the necessary bending moment to the end margin of the support portion or to force the end margins together and to hold the support member in any given position. The opposite end of the bowden cable is then attached to an actuator device that is typically either manually or electromechanically operated to tension the wire of the bowden cable and thereby to adjust the lumbar support portion of the seat.

During use of a typical adjustable lumbar support assembly, the tension of the wire of the bowden cable increases exponentially as the curvature of the support portion is increased. Thus, the actuator must also exert exponentially increasing tension on the wire of the bowden cable as the curvature of the support portion is increased. As a result, the design of both manually and electromechanically operated actuators is typically driven by the requirement of being able to provide peak tension. In light of this design concern, typical prior art actuators are generally inefficient during initial flexing of the lumbar support when the tension required is low.

A second design concern is the need to maximize lumber support travel in relation to actuator movement. It is inconvenient for a passenger to have to turn an actuator lever or wheel many times to move the lumbar support. User convenience will be provided to the extent that a bowden cable at the lumbar support end can be made to travel a farther distance than the distance the actuator pulls it at the user's end.

Finally, there is a constant need to decrease component size and cost.

### SUMMARY OF THE INVENTION

The present invention overcomes the disadvantages of prior art adjustable lumbar support assemblies by providing a bowden cable transmission between the actuator and the lumbar support member that converts movement of a first wire of a first bowden cable attached to the actuator into movement of a second wire of a second bowden cable attached to the lumbar support member. The bowden cable transmission converts the motions in a non-proportional manner such that the movement of the second wire in response to the movement of the first wire changes as the movement of the first wire is altered. In an adjustable lumbar support assembly, the non-proportional conversion allows movement of the first wire by the actuator to invoke larger movement of the second wire when the lumbar support member is relaxed and to invoke less movement in the second wire in response to the movement of the first wire when the lumbar support is substantially flexed.

In general, the bowden cable transmission assembly of the invention comprises a first bowden cable having a first sleeve and a first wire, and a second bowden cable having a second sleeve and a second wire. The assembly further comprises a transmission device having two pairs of connection points. The first pair has first and second connection points that are movable relative to each other. The first connection point is operatively connected to the first sleeve and the second connection point is operatively connected to the first wire in a manner such that movement of the first wire relative to the first sleeve imparts movement of the first connection point relative to the second connection point. The transmission device also comprises third and fourth connection points that are movable relative to each other. The third connection point is operatively connected to the second sleeve and the fourth connection point is operatively connected to the second wire in a manner such that movement of the third connection point relative to the fourth connection point imparts movement of the second wire relative to the second sleeve. The first, second, third, and fourth connection points are linked to each other in a manner such that movement of the first wire relative to the first sleeve causes non-proportional movement of the second wire relative to the second sleeve.

The invention provides a method of adjusting a lumbar support of a seatback that comprises the step of causing motion of a first wire of a first bowden cable relative to a first sleeve of the first bowden cable via a bowden cable actuator. The method also comprises converting the motion of the first wire into motion of a second wire of a second bowden cable relative to a sleeve of the second bowden cable with the conversion being non-proportional. The method further comprises adjusting the lumbar support in response to the motion of the second wire relative to the second sleeve.

While the principle advantages and features of the invention have been described above, a more complete and thorough understanding of the invention may be attained by referring to the drawings and the detailed description of the preferred embodiments which follow.

### BRIEF DESCRIPTION OF THE DRAWING FIGURES

FIG. 1 is an oblique view of an adjustable lumbar support assembly with the transmission device of the present invention schematically shown assembled thereto.

FIG. 2 is a side view of a typical prior art lumbar support member shown in a generally relaxed position.

FIG. 3 is a side view of the typical prior art lumber support member of FIG. 2 shown in a flexed position.

FIG. 4 is an oblique view of a first embodiment of the transmission device of the present invention shown in a relaxed position where the bowden cables attached thereto are unstressed.

FIG. 5 is an oblique view of the first embodiment of the transmission device shown in a contracted position where the bowden cables attached thereto are fully tensioned.

FIG. 6 is an oblique view of second embodiment of the transmission device of the present invention shown in a relaxed position where the bowden cables attached thereto are unstressed.

FIG. 7 is an oblique view of the second embodiment of the transmission device shown in a contracted position where the bowden cables attached thereto are fully tensioned.

FIG. 8 is an oblique view of a third embodiment of the transmission device.

Reference characters in the written specification indicate corresponding parts throughout the several views of the drawings.

### DETAILED DESCRIPTION OF THE PREFERRED EMBODIMENTS

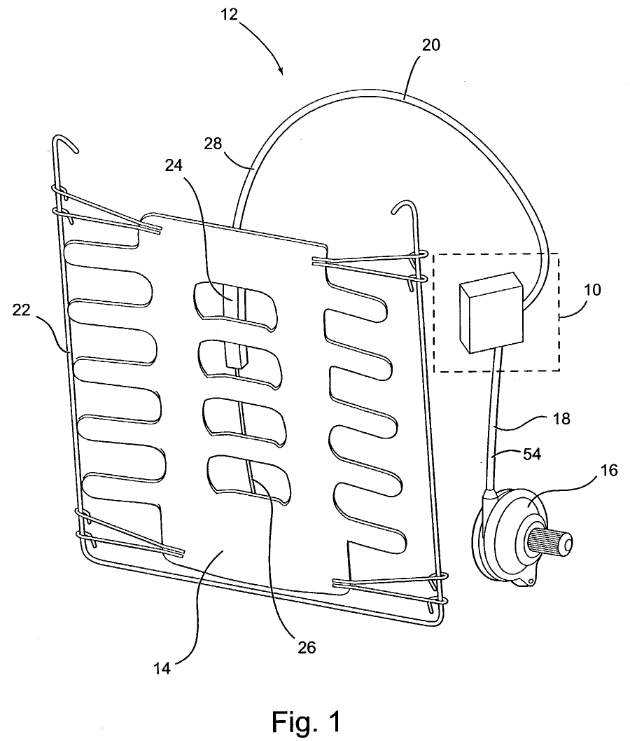

The preferred embodiments of bowden cable transmission device are configured and adapted for use in adjustable lumbar support assemblies of automobiles. FIG. 1 illustrates a bowden cable transmission device 10 in accordance with the present invention schematically shown assembled as part of an adjustable lumber support assembly 12.

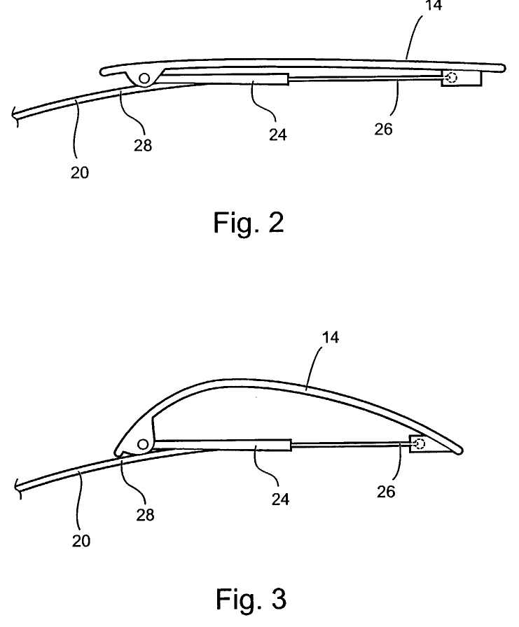

In addition to the bowden cable transmission device 10, the lumbar support assembly 12 comprises a lumbar support member 14, a bowden cable actuator 16, a first bowden cable 18, and a second bowden cable 20. The lumbar support member 14 is preferably a typical prior art support member formed of plastic, metal, or other suitable materials and is capable of resiliently deflecting. As shown, the lumbar support member 14 generally has the shape of a thin panel and is attached to a generally rigid seatback frame 22 where it is adapted to support a person's lower back. By applying a tensile force between the opposite top and bottom end margins of the lumbar support member 14, the curvature and contour of the lumbar support member 14 can be controlled or adjusted to achieve a desired level of comfort. As shown in FIGS. 2 and 3, the tensile force is applied via bowden cable, which in this particular lumbar support assembly 12 is the second bowden cable 20. In FIG. 2, the lumbar support member 14 is shown in a relaxed or undeflected state and the eire 26 of the second bowden cable 20 extends a maximum amount from the cable's sleeve 28. The terminal end of the sleeve 28 of the bowden cable 20 is attached to one of the end margins of the lumbar support member 14 via a tether 24 and the wire 26 is attached to the other end margin. In FIG. 3, the wire 26 of the second bowden cable 20 has been partially retracted into the cable's sleeve 28, thereby creating a tensile force between the end margins of the lumbar support member 14 causing it to deflect as shown.

Alternatively, any other type of bowden cable actuated lumbar support member could used. For example, although not shown, the lumbar support member could be of the type that is flexed by applying various bending moments to one or both of the opposite top and bottom end margins of the lumbar support member. Such bending moments are commonly induced by applying a force on one or more moment arms that typically extend from the backside of the lumbar support member. Some other lumbar supports extend a paddle from a mount or channel. Again, a bowden cable would supply the necessary force. Thus, various types of adjustable lumbar support members could be utilized in connection with the invention and the particular type utilized is not critical to the invention.

The bowden cable actuator 16 of the lumbar support assembly 12 is preferable a typical prior art bowden cable actuator that is either manually or electomechanically operated. The bowden cable actuator 16 is configured and adapted, as is well know in the prior art, to selectively and controllably apply a tensile force on the wire of a bowden cable. In the lumbar support assembly 12 of FIG. 1, the bowden cable actuator 16 is connected to the first bowden cable 18 and, as described below, supplies the force and motion necessary to cause the deflection of the lumbar support member 14.

It should be appreciated that in a typical prior art lumbar support assembly, a single bowden cable often connects the lumbar support member to the actuator. It should be further appreciated that the lumbar support assembly 12 of the present invention differs from the assemblies of the prior art only in that the first bowden cable 18 extending from the bowden cable actuator 16 is connected to the second bowden cable 20 extending from the lumbar support member 14 via the bowden cable transmission device 10. Thus, particular aspects of the lumber support member, the connection between the lumbar support member and the second bowden cable, the bowden cable actuator, and the connection between the bowden cable actuator and the first bowden cable are not critical to the invention and various alternatives known in the prior art or developed in the future could be also utilized with the present invention.

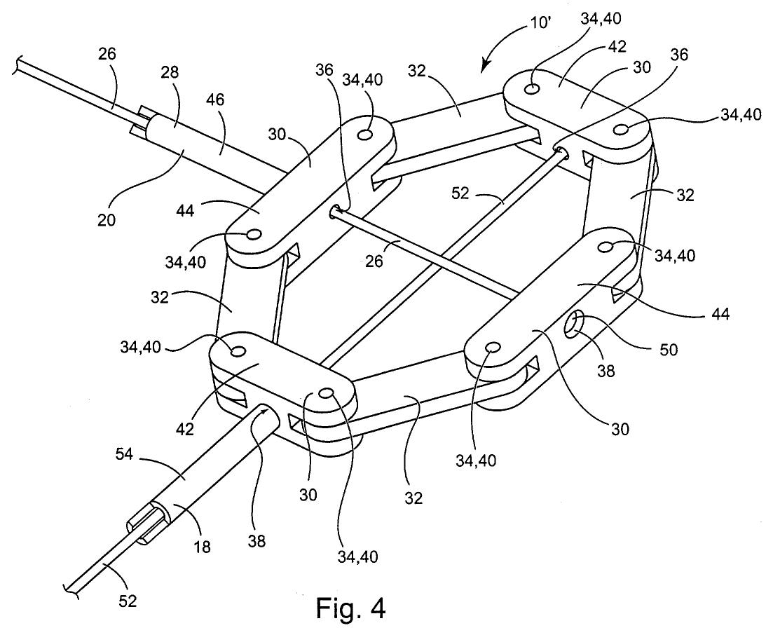

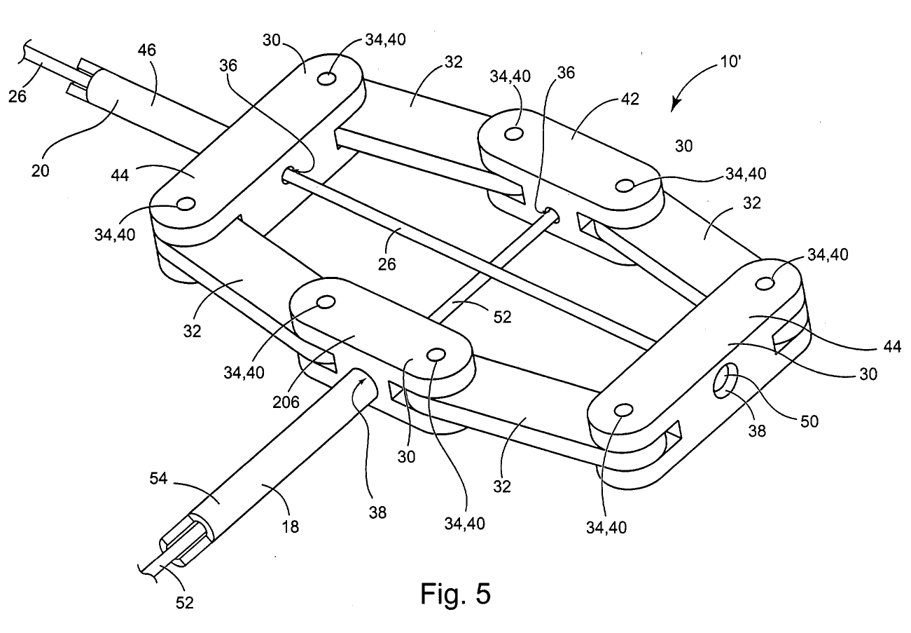

Having described the relative placement of the bowden cable transmission device 10 in the lumbar support assembly 12, a first embodiment of the bowden cable transmission device 10′ is shown in FIGS. 4 and 5. As shown, the first embodiment of the bowden cable transmission device 10′ generally comprises a plurality of tensioning members 30 that are connected to each other by a plurality of linking members 32. The tensioning members 30 and the linking members 32 are preferably formed of plastic, metal, or other suitable materials that are capable of transmitting loads.

Each of the tensioning members 30 of the first embodiment of the bowden cable transmission device 10′ is generally bar shaped and has a pivot connection 34 at each of its opposite longitudinal ends. A through-hole 36 extends laterally through the center of each of the tensioning members 30. A counterbore 38 is formed in each through-hole 36 and creates a recessed annular surface (not shown). Each of the linking members 32 the first embodiment of the bowden cable transmission device 10′ is also generally bar shaped and have a pivot connection 40 at each of its opposite longitudinal ends. The pivot connections 40 of the linking members 32 are complementary to the pivot connections 34 of the tensioning members 30.

The tensioning members 30 are connected to each other by the linking members 32 via the pivot connections 34,40. As assembled, a first pair 42 of tensioning members 30 are oriented spaced apart and with their respective through-holes 36 aligned and the counterbores 38 facing away from each other. Likewise, the remaining two tensioning members 30 that are oriented spaced apart and with their respective through-holes 36 aligned and the counterbores 38 facing away from each other. The through-holes 36 of the second pair 44 of tensioning members 30 are oriented between and at a right angle to the through-holes of the first pair 42 of tensioning members 30.

As shown in FIGS. 4 and 5, the first embodiment of the bowden cable transmission device 10′ operatively connects to the first 18 and second 20 bowden cables. As discussed above, the second bowden cable 20 comprises a wire 26 and a sleeve 28 and is attached at one end to the lumbar support member 14. At its opposite second end 46, the sleeve 28 terminates at an end margin and the wire 26 extends therefrom. The second end 46 of second bowden cable 20 is connected to the first embodiment of the bowden cable transmission device 10′ by passing the wire 26 through the through-holes 36 of both of the second pair 44 of tensioning members 30. The sleeve 28 of the second bowden cable is inserted in the counterbore (not shown) of nearest of the second pair 44 of tensioning members 30 until its end margin engages the recessed annular surface of the counterbore which prevents it from passing completely through the tensioning member. The free end of the wire 26 extends into the counterbore 38 of the opposite of the second pair 44 of tensioning members 30 and a retaining member 50 is attached thereto which then prevents the wire from passing back through the through-hole 36 of said tensioning member.

The first bowden cable 18 is attached to the first embodiment of the bowden cable transmission device 10′ in a manner similar to the second bowden cable 20 and, like the second bowden cable, comprises a wire 52 and a sleeve 54. Like the second bowden cable 20, the wire 52 of the first bowden cable passes through the through-holes 36 of the first pair 42 of tensioning members 30.

In use, the first embodiment of the bowden cable transmission device 10′ is configured as shown in FIG. 4 when the lumbar support member 14 is in a relaxed position. When desired, the bowden cable actuator 16 can be triggered to increase the tension of the wire 52 of the first bowden cable 18. As can be appreciated by one skilled in the art, this increase in tension causes the wire 52 of the first bowden cable passes through the through-holes 36 of the first pair 42 of tensioning members 30.

In use, the first embodiment of the bowden cable transmission device 10′ is configured as shown in FIG. 4 when the lumbar support member 14 is in a relaxed position. When desired, the bowden cable actuator 16 can be triggered to increase the tension of the wire 52 of the first bowden cable 18. As can be appreciated by one skilled in the art, this increase in tension cause the wire 52 of the first bowden cable 18 to force each of the first pair 42 of tensioning members 30 of the bowden cable transmission device 10′ toward the other. As should also be appreciated, the configuration of the linking members 32 and the pivot connections 34,40 causes the linking members to force each of the second pair 44 of tensioning members 30 away from the other as each of the first pair 42 of tensioning members 30 moves toward the other. This in turn causes the wire of the second bowden cable 20 to be pulled further out from the end margin of its sleeve 28.

As the first pair 42 of tensioning members 30 move toward each other, the second pair 44 of tensioning members 30 initially move away from each more quickly than they do when the first embodiment of the bowden cable transmission device 10′ approaches the configuration shown in FIG. 5, assuming the first pair of tensioning members are brought toward each other at a constant rate. This is due to the interconnecting configuration of the linking members 32 and the tensioning members 30 and as such, the movement of the wire 52 within the sleeve 54 of the first bowden cable 18 is related to the movement of the wire 26 within the sleeve 28 of the second bowden cable 20 in a non-proportional manner. In order words, the movement of the wire 26 of the second bowden cable 20 is not strictly a constant ratio of the movement of the wire 52 of the first boden cable 18.

As the second wire 26 moves, the lumbar support member 14 is deflected. As the deflection increases, the tension in the second wire 26 increase exponentially. Normally such an exponential increase in tensile force would be realized by actuator 16. However, due to the nonlinear conversion of movement between the wire 52 of the first bowden cable 18 and the wire 26 of second bowden cable 20 via the first embodiment of the bowden cable transmission device 10′, the tension in first bowden cable remains more consistent than it would otherwise. Additionally, using the bowden cable transmission device 10′, the total movement of the wire 52 of the first bowden cable 18 is able to impair a larger total movement of the wire 26 of the second bowden cable 20. This reduces the amount motion require by the actuator 16 to fully deflect and relax the lumbar support member 14. Finally, the transmission amplifier allows the use of components that are less expensive and more compact.

Although now shown, the first embodiment of the bowden cable transmission device 10′ of the invention is preferably enclosed in a housing. The housing is preferably shaped and configured to guide the tensioning members 30 along their intended paths of motion so as to keep the first 18 and second 20 bowden cables oriented at right angle relative to each other within the device. The housing also acts to prevent foreign objects from interfering with the moving parts of the bowden cable transmission device 10′.

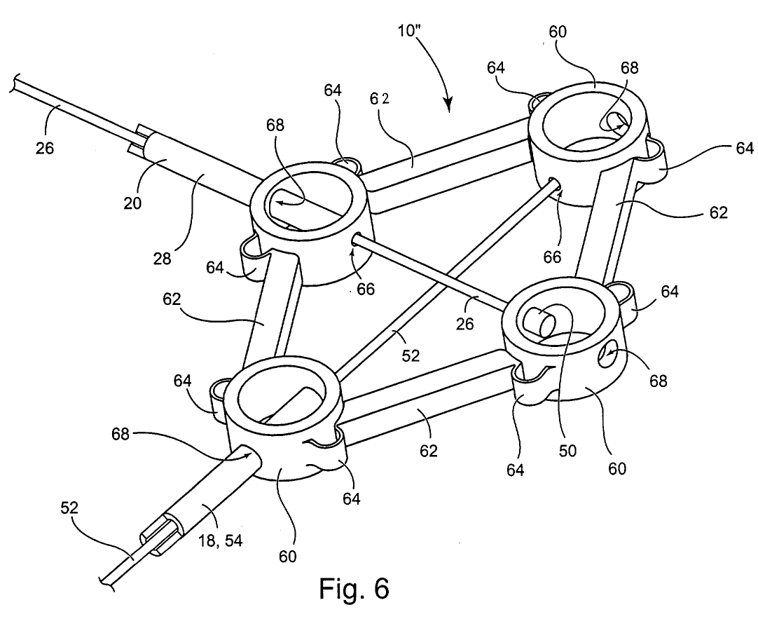

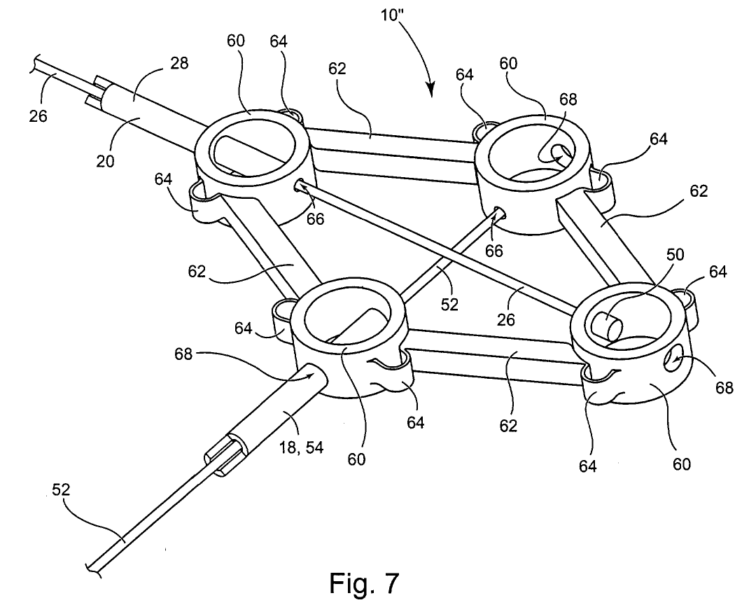

A second embodiment of the bowden cable transmission device 10″ is shown in FIGS. 6 and 7. The bowden cable transmission device 10″ of the second embodiment differs from that of the first embodiment in that its linkage assembly is formed as a single monolithic piece of material, preferably molded plastic.

The second embodiment of the bowden cable transmission device 10″ comprises four annual connection members 60 that are connected by four linkage members 62. The linkage members are joined to the connection members 60 via live hinges 64 that are formed integrally therewith. The live hinges 64 allow to linkage members 62 to generally pivot relative to the connection members 60. Each of the connection members 60 has a first hole 66 that extends through its annular wall and a second larger hole 68 that extends through its annular wall on the opposite side of the first hole. The larger second hole 68 is configured to allow the sleeve of a bowden cable to pass therethrough while the first hole 66 is configured to allow only the wire of such a bowden cable to pass therethrough. These first 66 and second 68 holes function in a manner similar to the through-holes 36 and counterbores 38 of the first embodiment, respectively.

In use, the second embodiment of the bowden cable transmission device 10″ operatively connects to the first 18 and second 20 bowden cables in a manner similar to the first embodiment. Likewise, the second embodiment of the bowden cable transmission device 10″ functions in a manner nearly identical to that of the first embodiment as it moves back a forth between a relaxed position as shown in FIG. 6 and a retracted position as Shown in FIG. 7. Furthermore, it should also be appreciated that the second embodiment of the bowden cable transmission device 10″ is preferably contained within a housing similar to that of the first embodiment.

While the present invention has been described in reference to specific embodiments, in light of the foregoing, it should be understood that all matter contained in the above description or shown in the accompanying drawings is intended to be interpreted as illustrative and not in a limiting sense and that various modifications and variations of the invention may be constructed without departing from the scope of the invention defined by the following claims. Furthermore, it should be understood that when introducing elements of the present invention in the claims or in the above description of the preferred embodiment(s) of the invention, the terms “comprising,” “including,” and “having” are intended to be inclusive and mean that there may be additional elements other than the listed elements.

What is claimed:

1. A transmission amplifier for connecting bowden cables comprising:
a transmission device, the transmission device comprising first and second connection points being movable relative to each other, the first connection point being operatively connected to the first sleeve and the second connection point being operatively connected to the first wire in a manner such that movement of the first wire relative to the first sleeve imparts movement of the first connection point relative to the second point, the transmission device also comprising third and fourth connection points being movable relative to each other, the third connection point being operatively connected to the second sleeve and the fourth connection point being operatively connected to the second wire in a manner such that movement of the third connection point relative to the fourth connection point imparts movement of the second wire relative to the second sleeve, the first, second, third, and fourth connection points being linked to each other.

2. The transmission amplifier of claim 1 wherein said connection points are linked in a manner such that movement of the first wire relative to the first sleeve causes non-proportional movement of the second wire relative to the second sleeve.

3. An assembly comprising:
a first bowden cable comprising a first sleeve and a first wire;
a second bowden cable comprising a second sleeve and a second wire; and
a transmission amplifier for connection bowden cables comprising a transmission device, the transmission device comprising first and second connection points being movable relative to each other, the first connection point being operatively connected to the first sleeve and the second connection point being operatively connected to the first wire in a manner such that movement of the first wire relative to the first sleeve imparts movement of the first connection point relative to the second point, the transmission device also comprising third and fourth connection points being movable relative to each other, the third connection point being operatively connected to the second sleeve and the fourth connection point being operatively connected to the second wire in a manner such that movement of the third connection point relative to the fourth connection point imparts movement of the second wire relative to the second sleeve, the first, second, third, and fourth connection points being linked to each other in a manner such that movement of the first wire relative to the first sleeve causes non-proportional movement of the second wire relative to the second sleeve.

4. An assembly in accordance with claim 3, wherein:
the first wire extends along the first path having a varying length between the first and second connection points and the second wire extends along a second path having a varying length between the third and fourth connection points, the linkage between the first, second, third, and fourth connection points being such that the length of the second path increases as the length of the first path decreases.

5. An assembly in accordance with claim 4, wherein:
the linkage between the first, second, third, and fourth connection points is such that the length of the second path increases at a decreasing rate when the length of the first path is decreased at a constant rate.

6. An assembly in accordance with claim 3, wherein:
the first path extends straight between the first and second connection points and the second path extends straight between the third and fourth connection points, the first path being oriented at a right angle to the second path.

7. An assembly in accordance with claim 3, further comprising:
first, second, third, and fourth connection members and first, second, third, and fourth linking members, the first, second, third, and fourth connection points being positioned on the first, second, third, and fourth connection members respectively, the first linking member directly linking the first connection member to the third connection member, the second linking member directly linking the first connection member to the fourth connection member, the third linking member directly linking the second connection member to the third connection member, the fourth linking member directly linking the second connection member to the fourth connection member, each of the linking members being configured and adapted to transmit compressional force between each of the connection members of which it is directly linked.

8. An assembly in accordance with claim 7, wherein:
each of the linking members is pinned to each of the connection members of which it is directly linked.

9. An assembly in accordance with claim 7, wherein:
the transmission device is a single homogeneous monolithic part.

10. An adjustable lumbar support assembly for a seatback, the lumber support device comprising:
an adjustable lumbar support device;
a bowden cable actuator;
and an assembly in accordance with claim 1, the first bowden cable being connected between the bowden cable actuator and the transmission device, the second bowden cable being connected between the transmission device and the lumbar support device.

11. An adjustable lumbar support assembly in accordance with claim 10, wherein:
the first wire extends along a first path having a varying length between the first and second connection points and the second wire extends along a second path having a varying length between the third and fourth connection points, the linkage between the first, second, third, and fourth connection points being such that the length of the second path increases as the length of the first path decreases and such that the length of the second path increases at a decreasing rate when the length of the first path is decreased at a constant rate.

12. A method of adjusting a lumbar support of a seatback comprising the steps:
causing motion of a first wire a first bowden cable relative to a first sleeve of the first bowden cable via a bowden cable actuator;
converting the motion of the first wire into motion of a second wire of a second bowden cable relative to a sleeve of the second bowden cable, the conversion being non-proportional;
adjusting the lumbar support in response to the motion of the second wire relative to the second sleeve.

13. A method in accordance with claim 12, wherein:
the first bowden cable extends along a first path that is connected to the bowden cable actuator and the second bowden cable extends along a second path that is connected to the lumbar support, the step of causing the motion of the first wire results in the first wire moving toward the bowden cable actuator along the first path, the step of converting the motion of the first wire into motion of a second wire results in the second wire moving away from the lumbar support along the second path.
